(19) United States
(12) Patent Application Publication
(10) Pub. No.: US 2017/0228807 A1
(43) Pub. Date: Aug. 10, 2017

(54) SYSTEM AND METHOD FOR CROWDSOURCING INFORMATION

(71) Applicant: Mutilo, San Jose, CA (US)

(72) Inventor: Cesar Galindo, San Jose, CA (US)

(21) Appl. No.: 15/259,289

(22) Filed: Sep. 8, 2016

Related U.S. Application Data
(60) Provisional application No. 62/293,492, filed on Feb. 10, 2016.
(60) Provisional application No. 62/302,368, filed on Mar. 2, 2016.

(51) Int. Cl. G06Q 30/06; G06Q 50/00; G06Q 20/12

(52) U.S. Cl. CPC G06Q 30/0623; G06Q 20/12; G06Q 50/01; H04L 67/10

(57) ABSTRACT

A method of crowdsourcing information includes receiving, one or more requests from one or more requester devices operated by one or more requesters, wherein a request of the one or more requests comprises a first indicator, a requester fee and an expiration time. Next, the method includes receiving, one or more submissions from one or more submitter devices operated by one or more submitters, wherein a submission of the one or more submissions comprises information associated with one or more products and services. Further, the method includes sending the one or more submissions to the one or more requester devices, wherein one or more display devices comprised in the one or more requester devices is configured to display the one or more submissions. Finally, the method includes providing one or more payments to the one or more submitters based on receiving the one or more submissions.

### CROSS-REFERENCE TO RELATED APPLICATIONS

The current application claims a priority to the U.S. Provisional Patent application Ser. No. 62/293,492 filed on Feb. 10, 2016 and the U.S. Provisional Patent application Ser. No. 62/302,368 filed on Mar. 2, 2016.

### FIELD OF THE INVENTION

Generally, the disclosure invention relates to an online crowdsourcing platform. More specifically, the disclosure relates to a real-time online crowdsourcing platform for obtaining product and service information.

### BACKGROUND

Modern network technology enables users to access a vast amount of human knowledge. This access enables an individual to instantly sift through massive quantities of data. To streamline this data sifting process, various applications and services have been developed. For example, search engines are designed to crawl through the available data and return information pertinent to a query. Although these search engines return large amounts of data, it is the user's job to determine the relevance and credibility of any results. Additionally, much of the information available on the internet is archaic. While the Internet is a useful tool for finding large amounts of data, there are gaps in the types of data available. For example, it is difficult to accurately measure the real-time data via internet searches. Another prominent gap in the Internet searchable data is generated by individuals who are not actively connecting to the internet. This second gap makes it difficult to actively compare the prices of products and services offered by local merchants. These limitations make it difficult for shoppers to find the best prices of products and services in their area.

Accordingly, there is a need for systems and methods for obtaining accurate and timely information related to locally available products and services.

### SUMMARY

A method of crowdsourcing information associated with one or more products and services is disclosed. The method includes receiving, one or more requests from one or more requester devices operated by one or more requesters, wherein a request of the one or more requests comprises a first indicator of each of one or more products and services, a requester fee and an expiration time. Next, the method includes receiving, one or more submissions from one or more submitter devices operated by one or more submitters, wherein a submission of the one or more submissions comprises information associated with one or more products and services. Further, the method includes sending the one or more submissions to the one or more requester devices, wherein one or more display devices comprised in the one or more requester devices is configured to display the one or more submissions. Finally, the method includes providing one or more payments to the one or more submitters based on receiving the one or more submissions.

According to some aspects, a system for crowdsourcing information associated with at least one of a product and a service is disclosed. The system includes a communication interface configured to receive, at least one request from at least one requester device operated by at least one requester, wherein a request comprises a first indicator of each of at least one of the product and the service, a requester fee and an expiration time. Further, the communication interface is configured to receive, at least one submission from at least one submitter device operated by at least one submitter, wherein a submission comprises information associated with at least one of the product and the service. Moreover, the communication interface is configured to send the at least one submission to the at least one requester device, wherein at least one display device comprised in the at least one requester device is configured to display the at least one submission. The system further includes a processor communicatively coupled to the communication interface, wherein the processor is configured to provide at least one payment to the at least one submitter based on receiving the at least one submission.

According to some aspects, a real-time online marketplace (or a price finding platform) for requesters (buyers) and submitters (sellers) of prices on local products and services is provided. The online marketplace is a digital system used to compare the prices of products and services offered by merchants within a specified geographic region. According to some aspects, a platform is provided to connect individuals searching for the price of a product or a service, with individuals willing to perform the research required to locate the desired item.

According to some aspects, the disclosed real-time online marketplace for buyers and sellers of prices on local products and services leverages the pervasive connectivity of the Internet technology to bridge the gaps between merchants and buyers. To accomplish this, the real-time online marketplace for buyers and sellers of prices on local products and services enables buyers to search for a particular product by generating search request bids. These bids are broadcast to other users who are in the area. The users that receive the bid notification receive compensation for their time, should they choose to locate the requested product information. In this way, the real-time online marketplace for buyers and sellers of prices on local products and services provides an incentive for users to provide accurate product information. Additionally, the accurate product information is used to enable buyers to compare and find the best merchants, regardless of merchant connectivity.

According to some aspects, a method of use in conjunction with, the real-time online marketplace for buyers and sellers of prices on local products and services, is a software program that runs on computing devices such as smartphones, tablets, laptops, and the like.

According to some aspects, a communications engine is tasked with managing all communication between computing devices running the price finding platform and the database. The communications engine transmits information using encrypted channels.

### BRIEF DESCRIPTION OF DRAWINGS

FIG. 1 illustrates an environment in which an embodiment of the present invention operates.

FIG. 2 is a block diagram of a server for crowdsourcing information associated with a product and a service, in accordance with an embodiment.

FIG. 3 illustrates a flowchart of a method for crowdsourcing information, in accordance with an embodiment.

FIG. 4 illustrates a functional process diagram of a method for crowdsourcing information, in accordance with an embodiment of FIG. 3.

FIG. 5 illustrates a flowchart of a method for crowdsourcing information, in accordance with a further embodiment.

FIG. 6 illustrates a graphical user interface relate to crowdsourcing information, in accordance with an embodiment.

FIG. 7 illustrates a flowchart of a method for a requester workflow in accordance with an embodiment.

FIG. 8 illustrates a flowchart of a method for a requester bidding workflow, in accordance with an embodiment.

FIG. 9 is a functional block diagram that enables multiple requesters to crowd source information related to products and services in accordance with an embodiment.

FIG. 10 illustrates a flowchart of a method for submitter workflow in accordance with an embodiment.

FIG. 11 is a functional block diagram that enables multiple submitters to use the crowdsourcing platform in accordance with an embodiment.

FIG. 12 illustrates a table showing data for requesters requesting prices and submitters submitting prices for one or more products and services on a crowdsourcing platform in accordance with an exemplary embodiment.

FIG. 13 illustrates a table showing data for requesters requesting prices and submitters submitting prices for one or more products and services on the crowdsourcing platform in accordance with another exemplary embodiment.

FIG. 14 illustrates a table showing data for payouts for multiple submitters submitting prices for a particular product or service on the crowdsourcing platform in accordance with another exemplary embodiment.

FIG. 15 illustrates an exemplary computing system that may be employed to implement processing functionality for various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary.

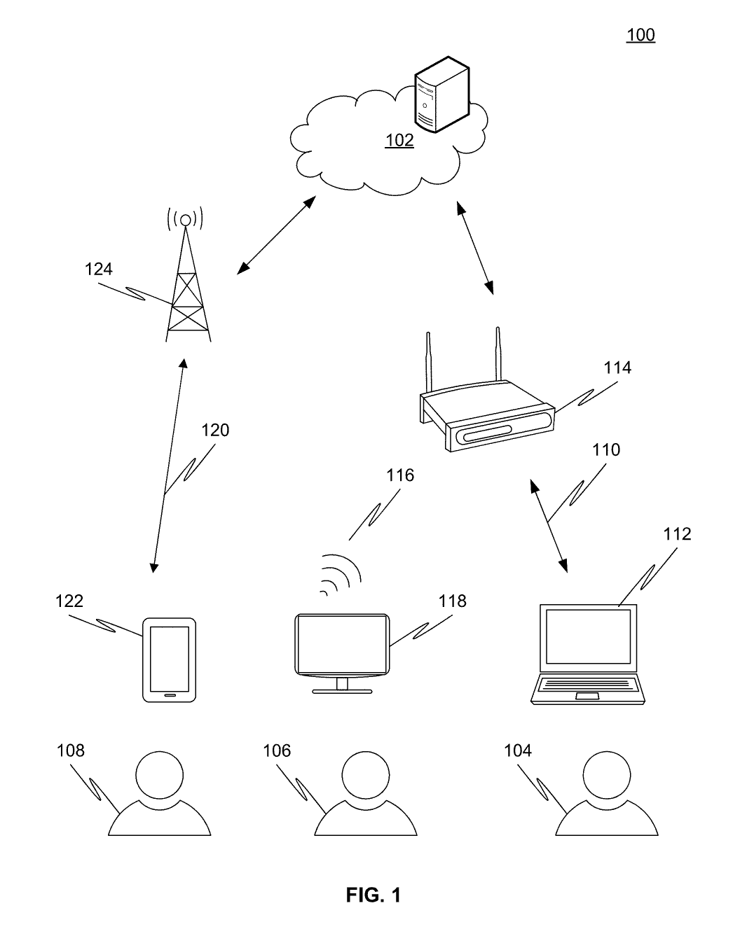

The present invention will be further illustrated with examples below. Referring first to FIG. 1 illustrating an environment 100 in which an embodiment of the present disclosure operates. The environment 100 includes a cloud server 102 configured to crowd source information associated with one or more products and services over the Internet. The information may be crowdsourced from multiple users 104-108. In an embodiment, the cloud server 102 hosts a crowdsourcing platform (or a price finding platform) that displays real-time product and service pricing information associated with one or more products and services available within a local geographical region. The crowdsourcing platform provides a real-time online marketplace for buyers and sellers of prices on local products and services.

The user 104 may connect to the cloud server 102 via Internet through a wired connection 110 between a laptop 112 and a modem 114. Similarly, the user 106 may connect to the cloud server 102 via Internet through a wireless connection 116 (Wi-Fi connection) between a desktop computer 118 and a modem, which may be the modem 114. Similarly, the user 108 may connect to the cloud server 102 via Internet through a wireless connection 120 (which may one of 3G, LTE, Wi-Fi connection) between a cell phone 122 and a cell tower 124.

The one or more users 104-108 may be requesters, wherein the term requester is used herein to refer to individuals using the crowdsourcing platform to compare prices for products and services from various merchants within a local geographical region. In general, the requesters are prospective buyers, who want to obtain and compare prices of a product or a service using the crowdsourcing platform. Similarly, the one or more users 104-108 may be submitters, wherein the term submitter refers to individuals who perform the research and determine the prices offered by merchants within a local geographical region. Further, a user in the users 104-108 may act as a requester at one point of time, but a submitter at another point of time.

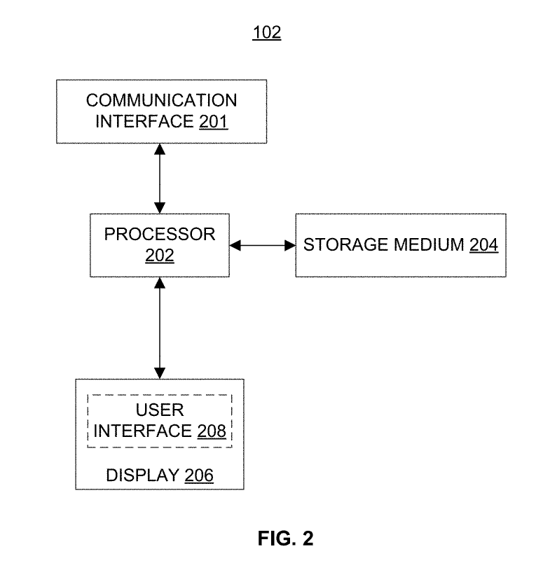

Now, referring to FIG. 2, the cloud server 102 is illustrated in accordance with an embodiment. The cloud server 102 includes a communication interface 201, one or more processors (for example, a processor 202), a storage medium (e.g., a memory) 204, and a display 206 (optional). The storage medium 204 stores instructions that, when executed by one or more processors 202, cause one or more processors 202 to provide crowdsourcing information in accordance with various embodiments. The communication interface 201 may be used to establish the connectivity to the cloud server 102. In an embodiment, the storage medium 204 may be a computer readable medium. The cloud server 102 may interact with the users via a user interface 208 accessible to the users via the display device 206 of any computing device such as laptops, smartphones, computers, tablets, etc.

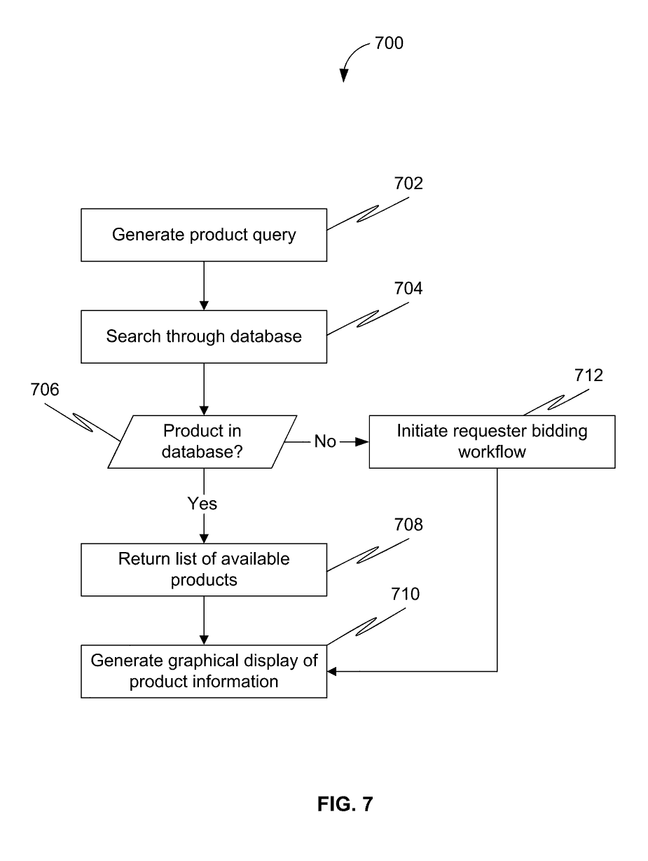

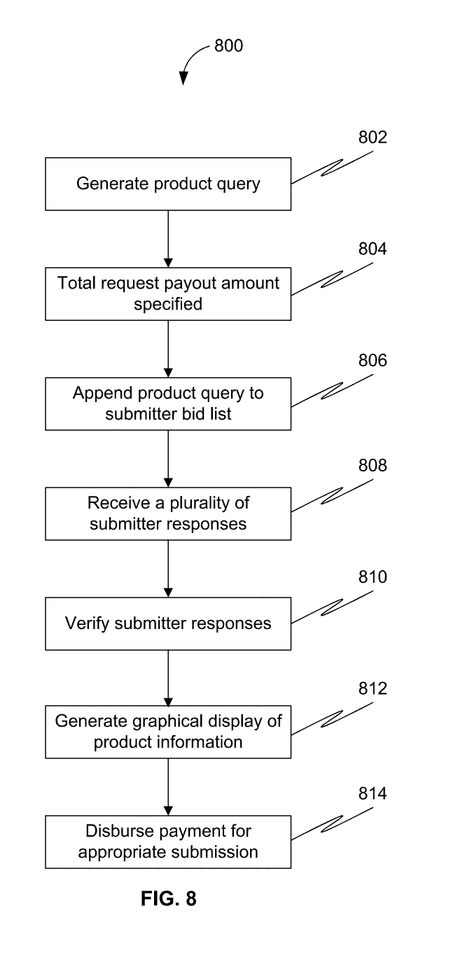

The crowdsourcing platform may include multiple software engines such as a user interface (UI) engine, a profile engine, a bidding engine, a transaction engine, a merchandise engine, a communications engine, and a database, which may be operated on one or more processors 202. The profile engine may manage user profile related processes and information. The UI engine may generate front-end graphical interfaces, which coordinate information flow between a user and the crowdsourcing platform. The UI engine may be configured to interpret the user input, render graphical interfaces, as well as generating alerts and notifications. For example, the UI engine may show real-time requests for product prices associated with the profile of each requester and submitter. The bidding engine, the transaction engine, the merchandise engine, and the communications engine are explained in detail in conjunction with FIGS. 7-8 below. The database may be used to store user information, product information, and other information required to operate the crowdsourcing platform. The database may be a cloud datacenter. Further, the crowdsourcing platform may employ multiple technologies such as, but not limited to, reactive, push/pull programming, and asynchronous exchange of information, to compare the prices of products and services offered by merchants within a specified geographic region.

The users 104-108 may access the crowdsourcing platform using a web browser. Alternatively, the users 104-108 may install a software application on their computing devices to access the crowdsourcing platform from the cloud server 102. The software application may be provided by the crowdsourcing platform.

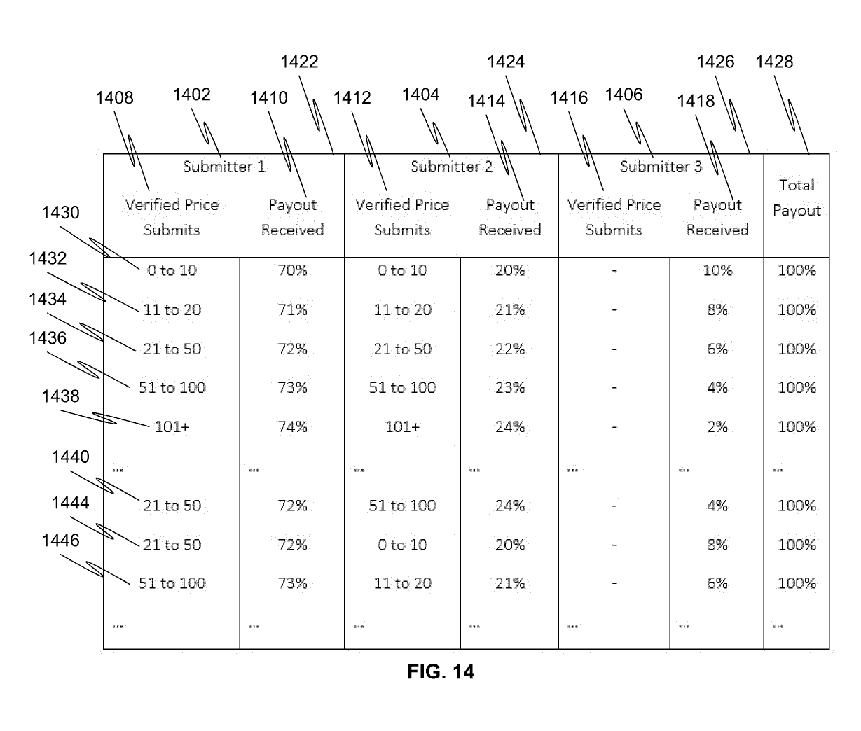

The one or more users 104-108 may create user profiles on the crowdsourcing platform (for example, by using the profile engine). A user profile may include all information for a particular user, such as, but not limited to, login details, location, user ratings, rankings, account balances, historical search data, and demographic information. Further, users may be able to create profile as one or more of a requester, submitter, or merchant. The one or more users 104-108 may be validated as qualified requesters, submitters and merchants when they create the user profile. Each user profile may receive a ranking based on various parameters, such as, but limited to, amount of time spent on the crowdsourcing platform, number of submitted responses, credibility of responses, and amount of money spent on the crowdsourcing platform. The ranking methodology is explained in further detail in conjunction with FIG. 14 below. The user profiles may be stored on the storage medium 204.

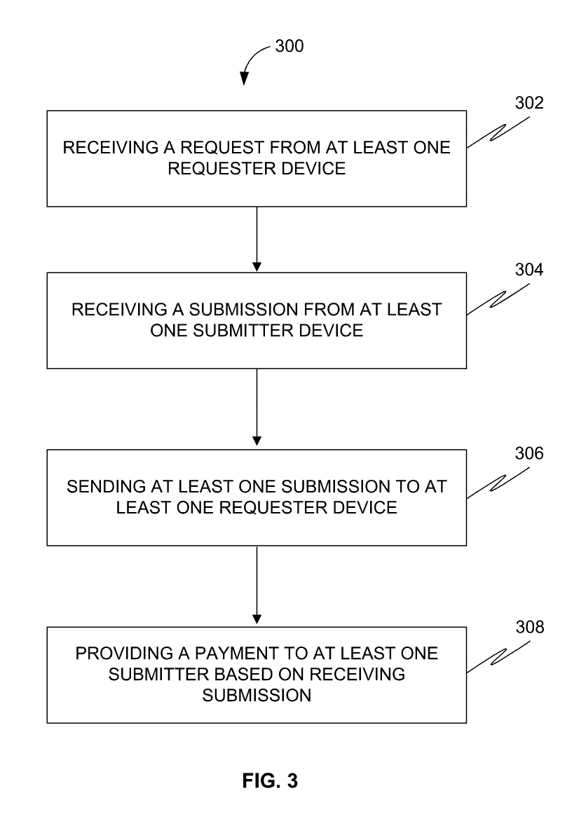

When required, the users 104-108 may log into the crowdsourcing platform using the login details in their user profile. After login, a user may view profile information such as location, user ratings, rankings, account balances, demographic information, and historical search data. Further, the user may deposit sums of money into corresponding user account. The deposited funds may be used to finance product or service searches. FIG. 3 illustrates a flowchart 300 of a method of crowdsourcing information in accordance with an embodiment. At 302, the crowdsourcing platform receives one or more requests from one or more requester devices operated by one or more requesters (from the users 104-108). Each of the one or more requests includes a first indicator of each of the corresponding one or more products and services, requester fees and expiration times. Further, the one or more requests may include a second indicator of a type of information associated with each of the corresponding one or more products and services. A requester device may be any computing device such as, but not limited to a laptop, a desktop, and a smartphone.

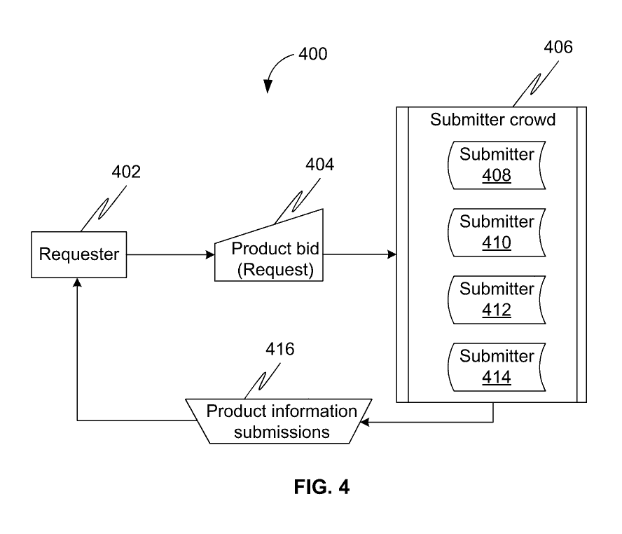

FIG. 4 illustrates a functional process diagram 400 of the method for crowdsourcing information. For example, as shown in FIG. 4, a requester 402 (for example, may be the user 104) may place a request 404 on the crowdsourcing platform using a requester device. Then, the crowdsourcing platform shares the request 404 with a submitter crowd 406, which includes multiple submitters 408-414 (may include the users 106-108).

Next, at 304, the crowdsourcing platform receives one or more submissions from one or more submitter devices operated by one or more submitters (may include the users 106-108). Each submission in the one or more submissions includes information associated with the one or more products and services. A submitter device may be any computing device such as, but not limited to a laptop, a desktop, and a smartphone. The information associated with the one or more products and services may include one or more of a price, a special offer, an identifier of a merchant and a location of the merchant. The location of the merchant may be within a predetermined distance from the location of the one or more requester devices.

For example, as shown in FIG. 4, one or more submitters 408-414 in the submitter crowd 406 may send one or more submissions 416 to the crowdsourcing platform.

Thereafter, at 306, the crowdsourcing platform sends the received one or more submissions to the one or more requester devices. For example, as shown in FIG. 4, the crowdsourcing platform sends the received one or more submissions 416 to the requester 402. Further, the crowdsourcing platform may store the one or more submissions in the database.

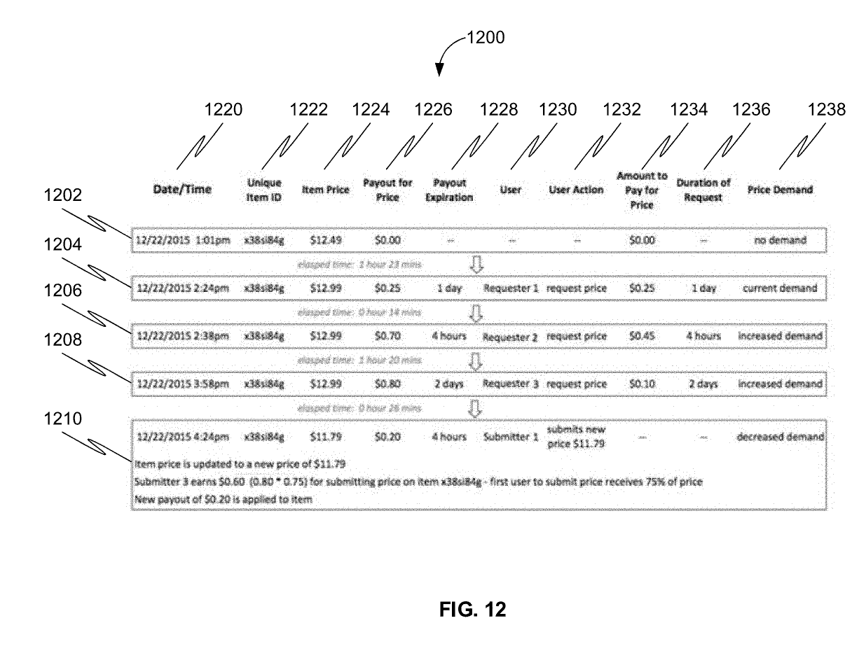

Each of the one or more requester devices includes a display device configured to display the one or more submissions. Accordingly, the one or more requester devices display one or more submissions corresponding to the one or more requested products and services. The one or more submissions may be displayed in a table as shown in FIG. 12 (refer, row 1210).

Thereafter, at 308, the crowdsourcing platform provides one or more payments to the one or more submitters based on receiving the one or more submissions at step 306. The one or more payments may be provided after the validating the information in the respective submissions. The validating the information may include performing a comparison among the multiple submissions received from a corresponding multiple submitters. Further, the validation may be performed by the corresponding one or more requesters.

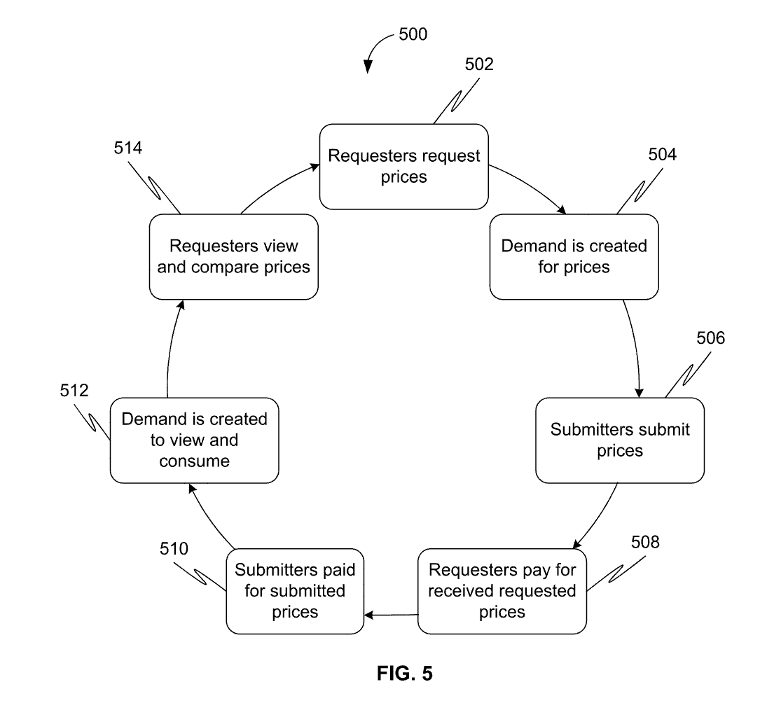

The one or more payments may be calculated based on multiple parameters, including but not limited to, respective requester fees, time of receiving the respective submissions, rating corresponding to the one or more respective submitters and the number of submissions received from each submitter. This is explained in further detail in conjunction with FIGS. 12, 13 and 14 below. The ratings corresponding to the requesters and the submitters may be obtained from the database of the crowdsourcing platform. Referring to FIG. 5 illustrating a flowchart 500 of a method for crowdsourcing information associated with a product and a service, in accordance with a further embodiment. At 502, one or more requesters use one or more requester devices to send one or more requests corresponding to one or more products and services. This step is similar to placing the request 404 as explained in conjunction with FIG. 4 above. The one or more requester devices may also send location of the respective devices along with the one or more requests. Each of the one or more requester devices may include a location sensor (such as GPS transceiver) to track the location of corresponding requester device. Moreover, one or more requesters include information about a requester fee and an expiration time in each request.

Once the one or more requests are received at the crowdsourcing platform, it creates a demand for prices for the corresponding one or more products and services at 504. Accordingly, one or more submitters may view the one or more requests on their one or more submitter devices. Each of the one or more submitter devices may also include a location sensor (such as GPS transceiver) to track the location of corresponding submitter device. The one or more requests may be displayed on the one or more submitter devices based on the location of the respective submitter devices. For example, a request is displayed on a submitter device based on proximity of the submitter location to the requester's location. The one or more requests may be displayed before the expiration time of the respective times. The expired requests are dynamically removed from the display. Further, the one or more requests may be validated before the one or more submitters can view the one or more requests. The received requests may be stored in the storage medium 204.

Thereafter, at 506, the one or more submitters operating the one or more submitter devices may submit price information corresponding to the one or more requests. Further, the submitters may submit additional information along with the price information such as, but not limited to, a product description, an availability, a special offer, a popularity, an identifier of a merchant selling the corresponding product or service and a location of the merchant. Multiple submitters may simultaneously submit the price information for the corresponding products and services offered by local merchants.

Next, at 508, the requesters receive the submissions made by the one or more submitters. Accordingly, the requesters pay for the submissions made by the one or more submitters. The requesters just pay the requester fees for the requests for which valid submissions are received. This step is similar to placing the request 404 to the submitter crowd 406 as explained in conjunction with FIG. 4 above.

Then, at 510, the one or more submitters receive payments corresponding to their submissions. This step is similar to the receiving submissions 416 explained in conjunction with FIG. 4 above. The crowdsourcing platform may split the requester fee for a particular request among the eligible one or more submitters based on various parameters, such as, but not limited to, time of submission, rating/ranking of the submitter and total number of submissions received for the corresponding request. This has been explained in further detail in conjunction with FIGS. 12, 13 and 14 below. Further, the crowdsourcing platform may dynamically update the credited amount to each submitter's profile.

The payments between the crowdsourcing platform, the requesters and the submitters may be managed by the transactions engine in the crowdsourcing platform. The transactions engine may be integrated with a payment gateway, such as, but not limited to, PayPal™, Auuthorize.net™, 2Checkout.com™, SecurePay.com™, Paynova™, and Google Wallet™.

At 512, the submissions create a demand for one or both of viewing and consuming prices. The submissions provide price information in near real-time to the corresponding requesters. Further, the submissions made by the one or more submitters are stored on the crowdsourcing platform. As the crowdsourcing platform receives more submissions for the same product or service, the price information stored on the crowdsourcing platform becomes more accurate. In future, the one or more requesters may search for one or more products and services in the stored submissions. If they find their one or more products and services in the stored submission, they use the information.

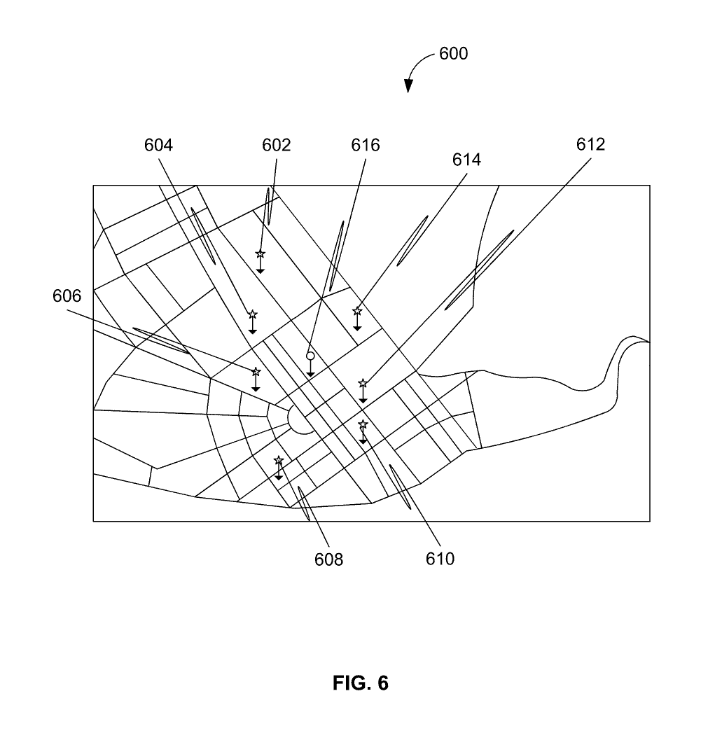

Next at 514, the one or more requesters may view and compare the submissions received. The one or more requesters may view the prices in a table as shown in FIG. 12. Further, the one or more requesters may view the submissions on a map 600 as shown in FIG. 6. The map 600 shows the real time locations of the various merchants mentioned in the one or more submissions. For example, for a particular requester, the map 600 shows the locations of merchants for a particular request made by the requester. The locations of the merchants are marked with “star” marks 602-614 on the map 600. Further, a location 616 of the requester may be shown using a “circle” mark on the map 600.

According to an embodiment, the requesters may have two methods 700 and 800 for determining the price of a product or service. The methods 700 and 800 are explained in detail in conjunction with FIGS. 7 and 8 below. In an embodiment, both of these methods may be executed by the bidding engine.

Referring to FIG. 7 illustrating a flowchart of a method 700 for requester workflow in accordance with an embodiment. The merchants may store information about their products and services in the database. The requesters may browse or search the products and services stored in the database. The products and services may be grouped into lists based on various parameters. Further, the requesters or submitters may share lists of products and services via social media outlets.

At 702, a requester generates a query comprising a third indicator representing a specific product or service using a requester device. Then, at 704, the crowdsourcing platform uses the query to perform a search in the database.

If the search locates the specific product or service in the database at step 706, then the method 700 returns a list of the available products and services offered by one or more merchants at 708. Finally, the list of the available products and services is displayed on the requester device. Accordingly, a graphical user interface such as 1200 or 600 may be generated to display the available products and services offered by one or more merchants at step 710. The user interface 600 is a map, which indicates the geographic position of merchants. The user interface 600 is a list of available products and services. The requester may then browse displayed list of available products and services and select a suitable merchant.

However, if the search does not locate the specific product or service in the database at step 706, then the method 700 initiates a requester bidding workflow 800 at 712. The crowdsourcing platform may prompt the corresponding requester to provide the one or more requests based on the searching. The requester bidding workflow 800 (shown in FIG. 8) includes generating a query for a specific product or service using a requester device at 802. This step is similar to 702 explained above.

Next, the requester specifies the requester fee to generate a request at 804. The requester fee is the price the requester will pay for locating a merchant offering the specified product or service. The requester may further include information such as, but not limited to, the name, ID, or description of the specific product or service, and the requester's location.

Then, the request is sent from the requester device to the crowdsourcing platform. The crowdsourcing platform includes the request in submitter's bid list at 806. Thereafter, multiple submitters may view the request in the submitter's bid list and send their submissions. The submissions are received by the crowdsourcing platform at 808. The crowdsourcing platform verifies the submissions at 810. Thereafter, a graphical display such as 1200 or 600 may be generated to display the product and service information at step 812. The step is similar to the step 710 explained above. Further, the requestor may receive notifications indicating submissions corresponding to the request have been received. Finally, the crowdsourcing platform disburses the payment for the appropriate submissions among the corresponding submitters at 814.

In another embodiment, the bidding engine is used to generate a query at 702 and transfer the query to the merchandising engine. At 704, the merchandising engine may perform the search in the database. At 708, the merchandising engine may return a list of the available products and services offered by one or more merchants and display the same on the requester device. At 710, the UI engine generates the user interfaces 1200 or 600 o display the available products and services offered by one or more merchants. Thereafter, at 802-804, the requester uses the bidding engine to generate a query and specify the requester fee to generate a request. At 806, the bidding engine includes the request in submitter's bid list. The bidding engine enables multiple submitters to provide information about the product or service desired by the requestor. Multiple submitters may respond to the requestor's request by providing bidding engine with information regarding pricing, location, and time sensitive specials. This product information is then transferred to the merchandising engine, which aggregates the responses from multiple submitters at 808. The requesters are then presented with the graphical user interfaces 600 or 1200 that displays a list of merchants offering the desired product or service. The location of the merchants may also be displayed. The UI engine generates the user interfaces 1200 or 600. The transaction engine then determines the payout for each submitter based upon various factors, such as submitter ranking, information relevance, and time of submission. Finally, at 814, the transaction engine makes the payments based on determined payouts.

Further, the communications engine is configured to manage all communication between computing devices running the crowdsourcing platform, user application and the database. The communications engine may use encrypted channels for all communication.

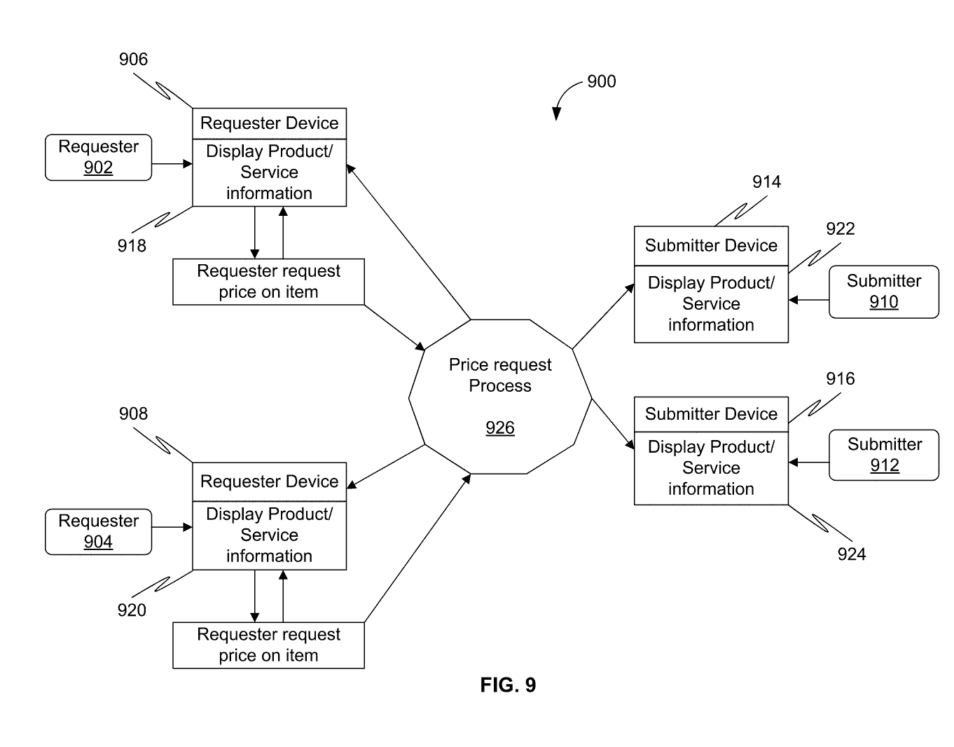

FIG. 9 is a functional block diagram 900 that enables multiple requesters 902-904 to crowdsource information related to products and services in accordance with an embodiment. The requesters 902-904 use requester devices 906-908 respectively, to place requests, view submissions corresponding to their requests and view information about stored products and services in the database. Multiple submitters 910-912 may view the requests on submitter devices 914-916 respectively.

Each of the requester devices 906-908 and the submitter devices 914-916 includes displays 918-924 respectively. The displays 918-924 display information including, but not limited to, name of products/services, description of products/services, price of products/services, date a particular price was submitted, payout amount and an expiration date of a payout.

Further, each of the requester devices 906-908 and the submitter devices 914-916 may be using a software application provided by the cloud server 102. The software application installed on the requester devices 906-908 and the submitter devices 914-916 enables these devices to communicate with a price request process 926. The price request process 926 performs various operations that enable multiple requesters 902-904 to crowdsource information from the multiple submitters 910-912. The price request process 926 may be executed on the cloud server 102. As shown, in 928, the requester 902 may generate requests for a product/service, which is then sent to the price request process 926. Similarly, in 930, the requester 904 may generate requests for a product/service, which is then sent to the price request process 926. The price request process 926 receives the price requests from the multiple requesters 902-904. For each new request, the price request process 926 calculates a new payout and a new expiration date of the corresponding product/service. Further, the price request process 926 shares updates (including new payouts and new expiration dates) with the requester devices 906-908 and the submitter devices 914-916. The displays 918-924 modify their views on receipt of updates from the price request process 926. Therefore, the price request process 926 enables processing of the requests in near real-time. In addition, it updates the requester devices 906-908 and the submitter devices 914-916 in near real-time.

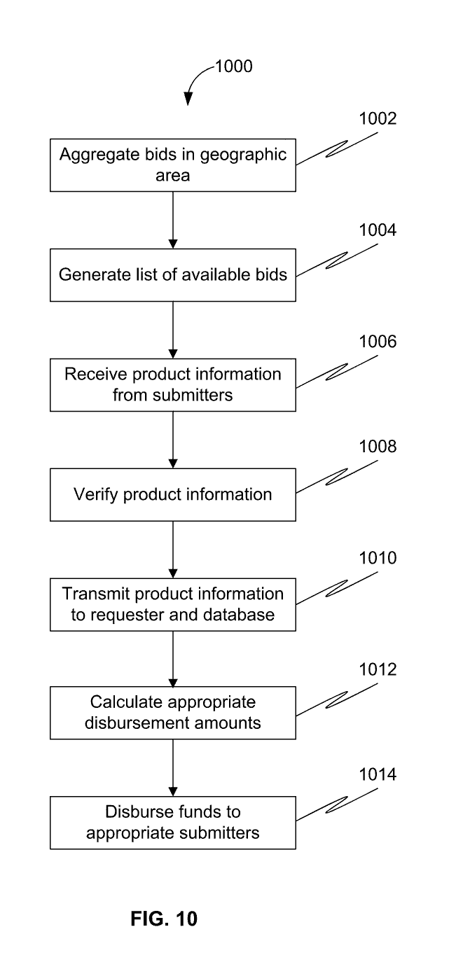

Referring to FIG. 10 illustrating a flowchart 1000 for a method for submitter workflow in accordance with an embodiment. At 1002, the crowdsourcing platform aggregates the requests received from a geographic area corresponding to each submitter. At 1004, the crowdsourcing platform generates a list of available requests, which is then displayed to corresponding submitters on their respective submitter devices.

Thereafter, the submitters provide submissions for the one or more requests in the list of available requests. The submissions are received at the crowdsourcing platform at 1006. Then, at 1008, the crowdsourcing platform verifies the submissions. Once verified, the accepted submissions are sent to the corresponding requesters and the database at 1010. Thereafter, the crowdsourcing platform calculates the appropriate disbursement amounts for the submitters at 1012. Finally, the crowdsourcing platform disburses the funds to appropriate submitters at 1014.

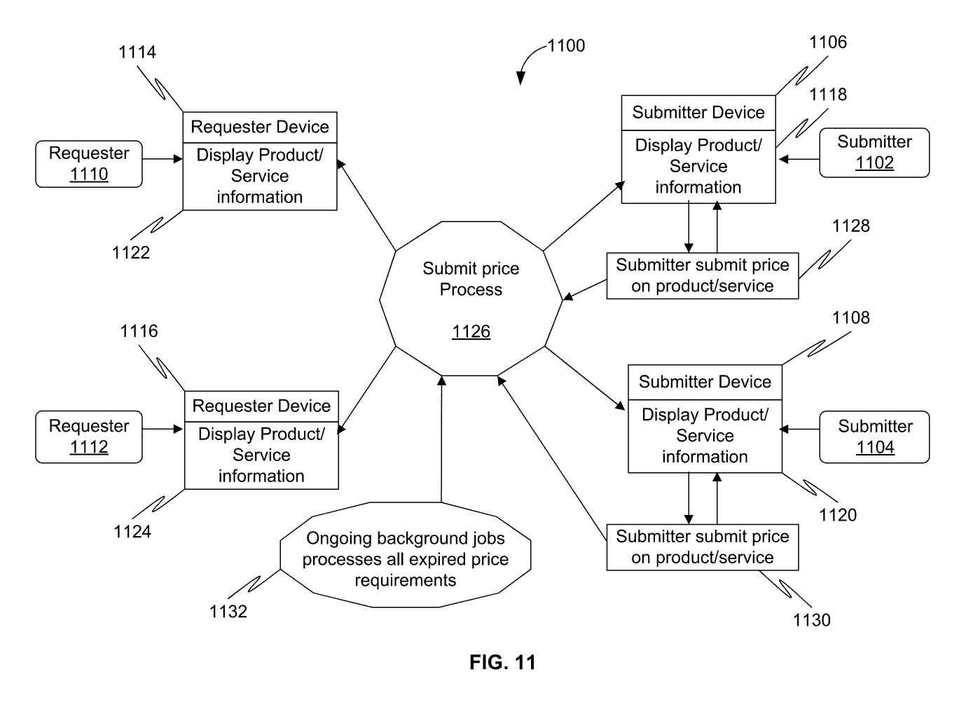

FIG. 11 is a functional block diagram 1100 that enables multiple submitters 1102-1104 to use the crowdsourcing platform in accordance with an embodiment. The submitters 1102-1104 use the submitter devices 1106-1108 respectively, to view requests, provide submissions corresponding to requests and view information about stored products and services in the database. Multiple requesters 1110-1112 may view the requests on requester's devices 1114-1116 respectively.

Each of the submitter devices 1106-1108 and the requester's devices 1114-1116 includes displays 1118-1124 respectively. The displays 1118-1124 display information including, but not limited to, name of products/services, description of products/services, price of products/services, date a particular price was submitted, payout amount and an expiration date of a payout.

Further, each of the submitter devices 1106-1108 and the requester's devices 1114-1116 may be using a software application provided by the cloud server 102. The software application installed on the submitter devices 1106-1108 and the requesters devices 1114-1116 enables these devices to communicate with a submit price process 1126. The submit price process 1126 performs various operations that enable multiple submitters 1102-1104 to provide submissions corresponding to various active requests. The submit price process 1126 may be executed on the cloud server 102. As shown, in 1128, the submitter 1102 may submit price for a product/service corresponding to a particular request, which is then sent to the submit price process 1126. Similarly, in 1130, the submitter 1104 may submit price for a product/service corresponding to a particular request, which is then sent to the submit price process 1126.

The submit price process 1126 receives the submissions from the multiple submitters 1102-1104. Further, submit price process 1126 performs one or more of calculating submitter payout, recording a transaction, calculating a new payout, calculating new expiration date. Further, the submit price process 1126 shares updates (including new payouts and new expiration dates) with the submitter devices 1106-1108 and the requesters devices 1114-1116. The displays 1118-1124 modify their views on receipt of updates from the submit price process 1126. Therefore, the submit price process 1126 updates the new price for a product or service in near real-time. Further, the submit price process 1126 removes the expired price requests. One or more operations performed by the submit price process 1126 may be performed in the background, as shown in 1132. FIG. 12 illustrates a table 1200 showing data for requesters requesting prices and submitters submitting prices for one or more products and services on the crowdsourcing platform in accordance with an exemplary embodiment. The table 1200 includes 5 rows 1202-1210 and 10 columns 1220-1238. The columns are titled as a column “Date/Time” 1240, a column “Unique Item ID” 1242, a column “Item Price” 1244, a column “Payout for Price” 1246, a column “Payout Expiration” 1248, a column “User” 1250, a column “User Action” 1252, a column “Amount to Pay for Price” 1254, a column “Duration of Request” 1256, and a column “Price Demand” 1258. The table 1200 may be displayed on the computing devices of one or more administrators, merchants, requesters and submitters.

The column “Date/Time” 1240 may show a current date and time of each entry in the table 1200. The column “Unique Item ID” 1242 may show an Identification code corresponding to a specific product or service. The column “Item Price” 1244 may show a current price of a product or service. The column “Payout for Price” 1246 may show the total amount one or more requesters will pay for receiving price information for particular product or service. The “Payout Expiration” 1248 may show an expiry time of a particular request. Further, the column “User” 1250 may show name or identification of a user corresponding to an entry in the table 1200. The column “User Action” 1252 shows the role played by a user (for example, a requester role or a submitter role). The column “Amount to Pay for Price” 1254 may show an amount a specific requester will pay for receiving price information for a particular product or service. The column “Duration of Request” 1256 may show a time limit for submissions a particular request. The column “Price Demand” 1258 may show a current status of demand for a particular product or service.

Detailed explanation of the calculations for the table 1200 is discussed herewith. Referring to the row 1202, at 12/22/2015 1:01 pm (column 1220), a merchant submits an item price of “$12.49” (column 1224) for a product with a unique item ID of “x38si84g” (column 1222). At this instance, the payout for price (column 1226) and the amount to pay for price (column 1234) is “$0.00” because the price demand (column 1238) indicates no demand for the current product.

Referring now to the row 1204, at 12/22/2015 2:24 pm (column 1220), a user “Requester 1” (column 1230) sends a request for the product with the unique item ID “x38si84g” (column 1222) and agrees to pay a payout of “$0.25” (column 1226). The payout expiration submitted by the Requester 1 is “1 day” (column 1228). Further, the amount of “$0.25” (column 1234) is reflected as the amount to pay for price. At this instance of time, the price demand (column 1238) for the requested product is updated to the “current demand”.

Proceeding to the row 1206, at 12/22/2015 2:38 pm (column 1220), a user “Requester 2” (column 1230) requests a price for the current product “x38si84g” (column 1222) at a payout of “$0.45” (column 1234). At this instance of time, the latest payout for price is updated to the price “$0.70” (column 1226). Further, the duration of request submitted by the “Requester 2” is “4 hours” (column 1228), which eventually increases the demand (column 1238) for the current product.

Now, referring to the row 1208, at 12/22/2015 3:58 pm (column 1220), a user “Requester 3” (column 1230) requests a price for the current product “x38si84g” (column 1222) at a payout of “$0.10” (column 1234). At this instance of time, the latest payout for price is updated to the price “$0.80” (column 1226). Further, the duration of request submitted by the “Requester 3” is “2 days” (column 1228), which eventually further increases the demand (column 1238) for the current product.

Moving to the last row 1210, at 12/22/2015 4:24 pm (column 1220), a user “Submitter 1” (column 1230) submits a new price of “$11.79” (column 1224), for the product with ID “x38si84g” (column 1222). After validation, the item price for the product is revised to $11.79. At this instance of time, the “Submitter 1” earns 75% of the payout price for the product, which in this case can be calculated using following equation:

Payout for “submitter 1”=75% of Payout for price

Therefore, the payout for “submitter 1”=0.75×0.80=50.60.

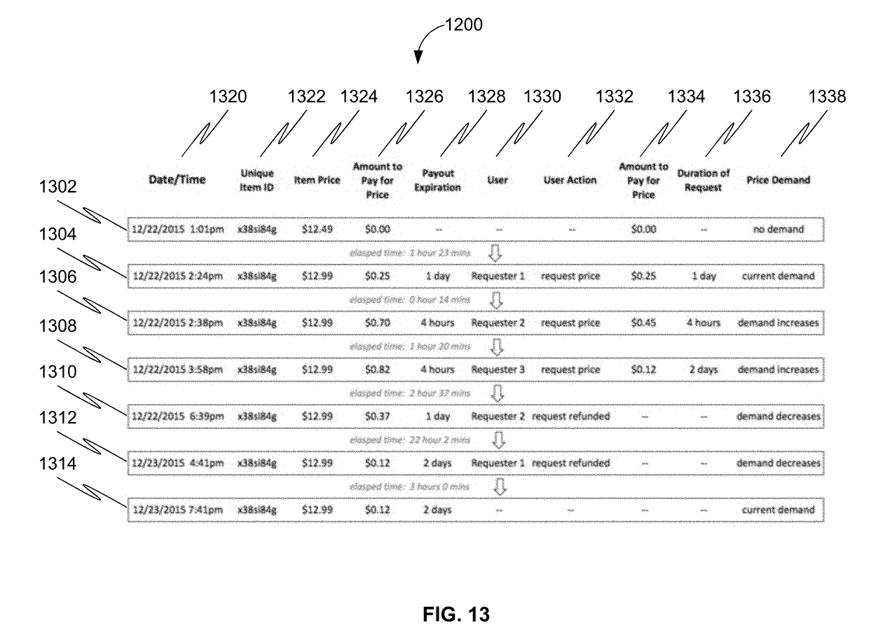

FIG. 13 illustrates a table 1300 showing data for requesters requesting prices and submitters submitting prices for one or more products and services on the crowdsourcing platform in accordance with another exemplary embodiment. The table 1300 includes 7 rows 1302-1314 and 10 columns 1320-1338. The columns are titled as a column “Date/Time” 1340, a column “Unique Item ID” 1342, a column “Item Price” 1344, a column “Payout for Price” 1346, a column “Payout Expiration” 1348, a column “User” 1350, a column “User Action” 1352, a column “Amount to Pay for Price” 1354, a column “Duration of Request” 1356, and a column “Price Demand” 1358. The table 1300 may be displayed on the computing devices of one or more administrators, merchants, requesters and submitters.

The table 1300 is similar to the table 1200. Table 1300 depicts data corresponding to a different scenario as compared to the table 1200. The rows 1304-1308 related to multiple requesters (1330) sending in requests (1332) for price for the product with ID “x38si84g” (column 1322). However, no submission is received from any submitter in the prescribed expiration times. Therefore, as shown in the rows 1310-1312, the amount is refunded (1332) to the multiple requesters (1330).

FIG. 14 illustrates a table 1400 showing data for payouts for multiple submitters submitting prices for a particular product or service on the crowdsourcing platform in accordance with another exemplary embodiment. For the particular product or service, the crowdsourcing platform is configured to split a payout among the multiple submitters. The crowdsourcing platform is further configured to reward payouts to submitters based on their individual ratings and rankings.

The table 1400 shows data corresponding to three submitters 1402-1406. For each submitter, the table 1400 shows number range of verified price submits and a corresponding percentage of a payout. For the submitter 1402, the table 1400 shows the number range of verified price submits in a column “verified price submits” 1408 and a corresponding percentage of payout in a column “payout received” 1410. For the submitter 1404, the table 1400 shows the number range of verified price submits in a column “verified price submits” 1412 and a corresponding percentage of payout in a column “payout received” 1414. For the submitter 1406, the table 1400 shows the number range of verified price submits in a column “verified price submits” 1416 and a corresponding percentage of payout in a column “payout received” 1418. The total payout is shown in a column 1428 in the table 1400.

The table 1400 includes multiple rows 1430-1446. Each row is related splitting a payout among the multiple submitters 1402-1406. The first and second submitters 1402-1404 are rewarded with a higher payout based on their higher rankings. Accordingly, the payout for the third submitter 1406 is reduced based on a lower ranking as compared to the ranking of the first and second submitters 1402-1404.

Further, as the submitters increase their number of verified price submits their rankings increase accordingly. For example, as shown in the row 1430, the first submitter 1402 receives 70% of the payout, the second submitter 1404 receives 20% of the payout, and the third submitter 1406 receives 10% of the payout. At this point of time, each of the first submitter 1402 and the second submitter 1404 has submitted 0-10 verified price submits.

As shown, the verified price submits of each of the first submitter 1402 and the second submitter 1404 increases from 0-10 (row 1430) to 11-20 (row 1432) to 21-50 (row 1434) to 51-100 (row 1436) to 101+ (row 1438). Correspondingly, the payout received for the first submitter 1402 increases from 70% (row 1430) to 71% (row 1432) to 72% (row 1434) to 73% (row 1436) to 74% (row 1438). Similarly, the payout received for the second submitter 1404 increases from 20% (row 1430) to 21% (row 1432) to 22% (row 1434) to 23% (row 1436) to 24% (row 1438). As the payout received for the first submitter 1402 and the second submitter 1404 increases, the payout received for the third submitter 1406 decreases such that the total payout stays at 100% (column 1428). As shown, the payout received for the third submitter 1406 decreases 10% (row 1430) to 8% (row 1432) to 6% (row 1434) to 4% (row 1436) to 2% (row 1438).

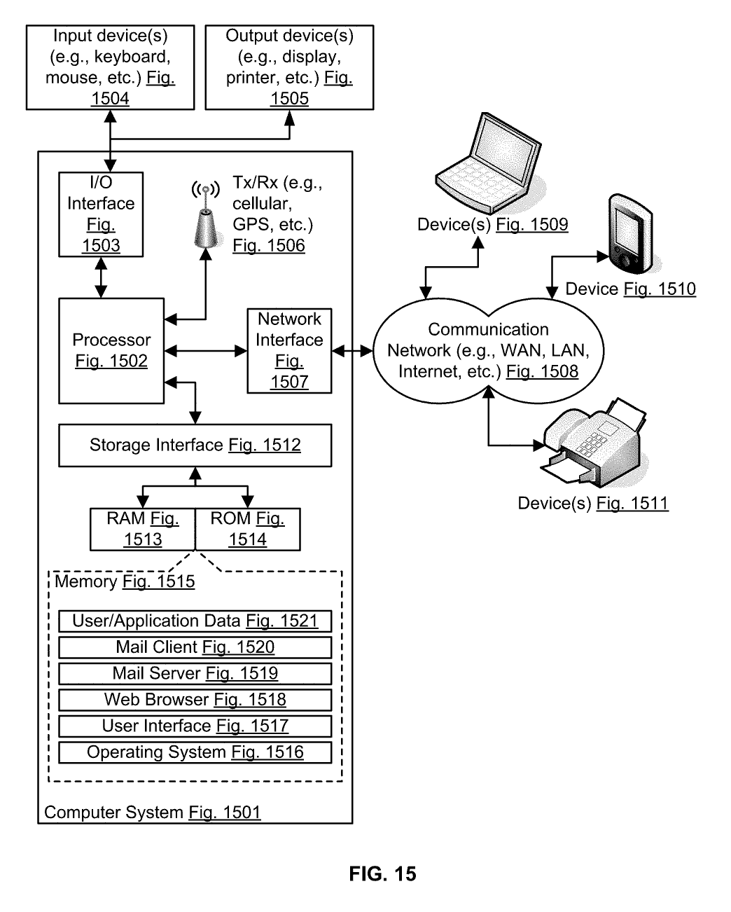

Referring now to FIG. 15, a block diagram of an exemplary computer system 1501 for implementing embodiments consistent with the present disclosure is illustrated. Variations of computer system 1501 may be used for implementing system 102 (the cloud server 102). Computer system 1501 may comprise a central processing unit (“CPU” or “processor”) 1502. Processor 1502 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 1502 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 1502 may be disposed in communication with one or more input/output (I/O) devices via I/O interface 1503. The I/O interface 1503 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 1503, the computer system 1501 may communicate with one or more I/O devices. For example, the input device 1504 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 1505 may be a printer, fax machine, video display (e.g., cathode ray tube (CRT), liquid crystal display (LCD), light-emitting diode (LED), plasma, or the like), audio speaker, etc. In some embodiments, a transceiver 1506 may be disposed in connection with the processor 1502. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 1502 may be disposed in communication with a communication network 1508 via a network interface 1507. The network interface 1507 may communicate with the communication network 1508. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 1508 may include, without limitation, a direct interconnection, local area network (LAN), wide area network (WAN), wireless network (e.g., using Wireless Application Protocol), the Internet, etc. Using the network interface 1507 and the communication network 1508, the computer system 1501 may communicate with devices 1509, 1510, and 1511. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 1501 may itself embody one or more of these devices.

In some embodiments, the processor 1502 may be disposed in communication with one or more memory devices (e.g., RAM 1513, ROM 1514, etc.) via a storage interface 1512. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices 1515 may store a collection of program or database components, including, without limitation, an operating system 1516, user interface application 1517, web browser 1518, mail server 1519, mail client 1520, user/application data 1521 (e.g., any data variables or data records discussed in this disclosure), etc. The operating system 1516 may facilitate resource management and operation of the computer system 1501. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 1517 may facilitate display, execution, interaction, manipulation, or operation of program components through textual or graphical facilities. For example, user interfaces may provide computer interaction interface elements on a display system operatively connected to the computer system 1501, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 1501 may implement a web browser 1518 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 1501 may implement a mail server 1519 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 1501 may implement a mail client 1520 stored program component. The mail client may be a mail viewing application, such as Apple Mail, Microsoft Entourage, Microsoft Outlook, Mozilla Thunderbird, etc.

In some embodiments, computer system 1501 may store user/application data 1521, such as the data, variables, records, etc. (e.g., keywords, requirements, test cases, test scripts, sub requirements, and so forth) as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

We claim:

1. A method of crowdsourcing information associated with at least one of a product and a service, the method comprising:
receiving, at least one request from at least one requester device operated by at least one requester, wherein a request of the at least one request comprises a first indicator of each of at least one of the product and the service, a requester fee and an expiration time;
receiving, at least one submission from at least one submitter device operated by at least one submitter, wherein a submission of the at least one submission comprises information associated with at least one of the product and the service;
sending the at least one submission to the at least one requester device, wherein at least one display device comprised in the at least one requester device is configured to display the at least one submission; and
providing at least one payment to the at least one submitter based on receiving the at least one submission.

2. The method of claim 1, wherein the information associated with at least one of the product and the service comprises at least one of a price, a special offer, an identifier of a merchant and a location of the merchant.

3. The method of claim 2, wherein the location of the at least one requester device is within a predetermined distance from the location of the merchant.

4. The method of claim 1 further comprising validating the information comprised in the submission.

5. The method of claim 4, wherein validating the information comprises performing a comparison among a plurality of submissions received from a corresponding plurality of submitters.

6. The method of claim 4, wherein providing the at least one payment is based on validating the information.

7. The method of claim 1, wherein providing the at least one payment is based on the requester fee corresponding to each of a plurality of requesters.

8. The method of claim 1, wherein providing the at least one payment is based further on a time of receiving the submission from the submitter.

9. The method of claim 1 further comprising receiving at least one rating corresponding to at least one of the at least one requester and the at least one submitter.

10. The method of claim 9, wherein providing the at least one payment is based further on the at least one rating corresponding to the at least one submitter.

11. The method of claim 1, wherein providing the at least one payment is based further on a number of submissions received from the submitter.

12. The method of claim 1, wherein the request further comprises a second indicator of a type of information associated with at least one of a product and a service.

13. The method of claim 1, wherein a requester device of the at least one requester device comprises a location sensor configured to determine a location of the requester device.

14. The method of claim 1 further comprising storing the at least one submission in a database.

15. The method of claim 1 further comprising deducting at least one account associated with the at least one requester based on receiving the at least one request, wherein providing the at least one payment comprises depositing the at least one payment into at least one account associated with the at least one submitter.

16. The method of claim 1 further comprising displaying the at least one request on at least one display device comprised in the at least one submitter device, wherein the at least one submission is received in response to displaying the at least one request.

17. The method of claim 16 further comprising determining at least one submitter location of the at least one submitter device, wherein the displaying is based on a proximity of the at least one submitter location to at least one requester location of the at least one requester device.

18. The method of claim 16, wherein the at least one submission is received prior to the expiration time.

19. The method of claim 1, wherein the at least one request comprises a plurality of requests comprising a plurality of expiration times respectively, wherein the at least one payment is calculated based on each of the requester fee, the plurality of expiration times and a time at which the at least one submission is received.

20. The method of claim 14 further comprising:
receiving a query comprising a third indicator of at least one of the product and the service;
searching the database for information associated with at least one of the product and the service based on the query; and
displaying the information associated with at least one of the product and the service on the at least one display device comprised in the at least one requester device based on the searching.

21. The method of claim 20 further comprising prompting the at least one requester to provide the at least one request based on the searching.

22. A system for crowdsourcing information associated with at least one of a product and a service, the system comprising:
a communication interface configured to:
receive, at least one request from at least one requester device operated by at least one requester, wherein a request comprises a first indicator of each of at least one of the product and the service, a requester fee and an expiration time;
receive, at least one submission from at least one submitter device operated by at least one submitter, wherein a submission comprises information associated with at least one of the product and the service; and
send the at least one submission to the at least one requester device, wherein at least one display device comprised in the at least one requester device is configured to display the at least one submission; and
a processor communicatively coupled to the communication interface, wherein the processor is configured to provide at least one payment to the at least one submitter based on receiving the at least one submission.
